(19) United States
(12) Patent Application Publication
(10) Pub. No.: US 2009/0278100 A1
(43) Pub. Date: Nov. 12, 2009

(54) Mower deck jack lever

(76) Inventor: Elizabeth Bowman, Wichita, KS (US)

Correspondence Address: KENNETH H. JACK, 2121 MAPLE, WICHITA, KS, 67213, US

(21) Appl. No.: 12/151,656

(22) Filed: May 8, 2008

(51) Int. Cl. B66F 5/00

(52) U.S. Cl. 254/8 R

(57) ABSTRACT

An apparatus for elevating a lawn mower deck, comprising a handle, that may be comprised of two sections that are angled with respect to each other, and an extension arm that is angled in relation to the handle, having an angled difference of less than 90 degrees, where the handle and extension arm pivot about a set of wheels. The apparatus is fixed to a mower deck using drilled holes in the front deck wheel flanges, or through the use of a plate that has the necessary defined holes, that is also fixed to the mower deck. The extension arm utilizes a pin that is placed in the extension arm pivot hole, and also through a corresponding hole on the plate, and where the movement of the handle toward the ground causes the extension arm to raise the mower deck. The apparatus is fixed in position using a second pin, that locks the movement of the arm and deck, in relation to each other. The rotation of the jack lever exceeds 90 degrees, so that the mower deck is first raised, and then slightly lowered to a resting position. This allows the mass of the mower deck to assist in maintaining the raised position.

### BACKGROUND OF THE INVENTION

High end riding lawn mowers are generally constructed with generous mowing decks that allow multiple blades and cover a significant area for cutting purposes. These mowing decks extend outward to the sides for a considerable distance. As a result of the greater size, these high end riding lawn mowers have a significant mass and require sturdy equipment to raise up the mower deck for purposes of maintenance. Generally, such mowers can only be serviced underneath the mowing deck through the use of hydraulic or mechanical jacks. Unlike a typical push mower, the high end riding lawn mower cannot be simply lifted up by hand or flipped on its side for inspection.

Prior art has shown an attempt to create a lifting means for machinery and equipment that is not as large or heavy as an automobile, but which is too heavy to manually elevate. In U.S. Pat. No. 5,441,378 (Puls), a snowmobile lift dolly is shown. Although this particular patent uses a lever for lifting purposes, it also requires a supporting frame. The present invention does not require a supporting frame. In U.S. Pat. No. 5,618,030 (Eggert), another snowmobile jack is shown. This patent has some similarities to the Puls patent noted above, but is much more simplistic in its design. This invention required a rectangular base, a triangular frame, and a handle that was pivotally attached to the frame, as well as a cable to secure the position of the handle. Although this patent may be considered an improvement over the Puls patent, both require some type of frame or base which the present patent does not.

In U.S. Pat. No. 5,678,804 (Lintelman et al.), a device for elevating lawnmowers is shown. This lifting device uses a wheel at the pivot point. An axle, a foot assistance means, a safety arm, and a support element and supporting means are all required for this invention. The safety arm appears to be an improvement over prior attempts, but the angle of the respective members appears to be set at approximately 90° or vertical. This invention also requires a safety means to prevent the entire assembly from flipping during use. The construction of the present invention and the use of a locking pin combine to provide a stable assembly during use.

Another example is shown in U.S. Pat. No. 5,713,557 (Kang), which covers a vehicle jack. This jack uses an axle as well as support blocks and support plates to maintain position of this invention during use. It appears to be particularly adapted for a car or some other heavy object, rather than the riding lawn mower to which the present invention is particularly adapted to.

U.S. Pat. No. 5,826,857 (Brack et al.) discloses a lifting means for a small vehicle or mower. Although the lever arm and the lifting arm portion of this invention have a similar orientation as the present invention does, the present invention is particularly adapted to certain attachment points on a riding lawn mower deck, and the present invention also utilizes simplistic but extremely effective locking means to increase the safety and utility of it.

U.S. Pat. No. 6,409,151 (Cormier) also discloses a mechanical jack in which a basic lever assembly is used. This jack appears to be somewhat adjustable, but requires a stationary frame support member with a single straight-line lifting member, and would not function in the same manner or provide the same safety features as the present invention does.

### SUMMARY OF THE INVENTION

This invention comprises a lever arm that is attached at one end to a jack arm, where the jack arm and lever arm both pivot around an axle which has wheels defined on the axle terminating ends. The jack arm and a lever arm have an angular difference of 90° or less, preferably with an angular difference between 75° and 90°.

The second end of the lever arm may have a lever arm extension, where said lever arm extension may also be at a slight angle in relation to the lever arm. Therefore, when the lever arm is horizontal to the ground, and able to contact the ground, the jack arm will be angled slightly from a 90 degree angle, so that the connection end of the jack arm is positioned over the lever arm, when the lever arm is on the ground. The lever arm extension may also be angled in relation to the lever arm, so that when said lever arm is on the ground, the extension arm is angled slightly so that it is raised up from the ground in proportion to the distance from its attachment point to the lever arm. The lever arm extension may be detachable from the lever arm, for storage purposes.

A mower or other contrivance that has an attachment point close to the ground has a lock plate attached to the mower or other contrivance. The lock plate defines a plurality of holes, including mounting apertures, a pivot hole and a lock hole. The lock plate should have sufficient rigidity and strength so that it is able to resist deformation or breakage when supporting the mower or other contrivance to which it is attached, where said mower or contrivance is elevated by force being applied to the lock plate.

A typical high-performance riding mower has a mower deck that is supported by a frame assembly. The frame assembly will have wheels that support said frame assembly, which in turn support the mower deck above the ground. The mower deck also may have its own deck wheels, which are rigidly attached to the mower deck and prevent the mower deck itself for making contact to any level ground. Such deck wheels may be positioned at various points around the mower deck, and it is very common for such wheels to be mounted on the very center and forward portion of the mower deck. These deck wheel mountings allow a lock plate to be attached to them. The lock plate may have one or more mounting apertures, which can accommodate the axle of the deck wheel, as well as another mounting bolt to fix the lock plate in position against the deck wheel support.

The mower deck jack is moved into position, so that the lever arm is fairly perpendicular to the ground surface, with the jack arm positioned so that its mounting end is able to be placed adjacent to the lock plate. The mounting end of the jack arm has a pivot hole and a locked hole defined through said Jack arm end. A pivot pin is placed through the jack arm pivot hole, with said pivot pin also been placed through the pivot hole of the lock plate.

Once the jack arm is pivotally attached to the lock plate, the lever arm is pulled backwards, or away from the mower. The lever action of the lever arm causes the jack arm to raise up in response to the lever arm moving downward. The lower deck jack will move forward on its wheels toward the mower deck, until the jack arm is perpendicular to the ground. At that point, the lever arm is slightly above the ground in angular position, and by pushing down on the lever arm towards the ground, the Jack arm will move past a perpendicular or 90 degree orientation, until the lever arm is on the ground surface. At this point, the lever arm is either horizontal to the ground or physically resting on the ground, with the jack arm holding up the mower deck, with the jack arm being at an angle so that the lower deck has moved slightly over and past the axle of the mower deck jack wheels. At this position, the mower deck mass presses downward and assists in maintaining a secure position. The lever arm extension, due to the fact that it is angled slightly, does not rest on the ground at the grip end, and is able to be manipulated when so desired so as to raise up the lever arm which in turn pushes that jack arm forward until the mower deck is passed the position with the jack arm is at 90°, and then is able to be lowered as desired.

The safety features of this invention comprised a lock hole defined in the lock plate, which corresponds to an another lock hole defined on the attachment end of the jack arm. When the jack arm has been moved to its resting upright position, so that the lever arm is on the ground, a lock pin hole defined in the lever arm will correspond to position to a lock hole defined on the lock plate. Therefore, when the mower deck is elevated, a lock pin may be positioned through the lever arm lock hole, and also through the lock plate lock hole, and where said pin is secured. Once this is accomplished, the mower deck is unable to move appreciably in relation to the jack arm. Since the jack arm is at an angled position, in which the mower deck mass is partially over the jack arm, the only way the mower deck can return down to the ground is for it to move slightly upward as the jack arm moves forward. Since movement of the lower deck in relation to jack arm is prevented by the lock pin, the lower deck jack is stable during use. Further, this attachment means, comprising a lock plate, is a simple modification to virtually every type of riding mower that has a front accessible mowing deck. Other small vehicles may also have such a fitting applied, so that the mower deck jack is able to work with any type of machinery or object.

Accordingly, it is an object of this invention to provide a simplistic means to elevate the front portion of the mower deck of a riding mower.

It is a further object of this intention to provide a means whereby the means to elevate the front portion of the mower deck of a riding mower provides a stable elevation point, whereby the mower is unable to accidentally lower from the jack position.

Is a further object of this intention to provide a means to attach a mower deck jack to a riding mower deck, or any other portion of the riding mower desired, where the modification is simple so that they can be done after manufacture, or can be done during manufacture as a simple addition of a lock plate or appropriately drilled holes on a mower deck wheel support.

### DESCRIPTION OF THE FIGURES

FIG. 1 is a perspective view of the jack lever, in which the jack lever is positioned and attached to a mower deck in a lowered position.

FIG. 2 is a perspective view of the jack lever shown in that position it maintains when elevating the mower deck.

FIG. 3 is a perspective view of the plate that is used to connect the jack lever to the mower deck.

FIG. 4 is a perspective view of the extension arm of the jack handle, shown attached to the mower deck through the plate, while the mower deck is in a lowered position.

FIG. 5 is a perspective view of the extension arm with the mower deck elevated, and the locking pin put into place.

FIG. 6 is a perspective view of the jack lever and safety arm, where the jack lever is in an upright position.

FIG. 7 is a perspective view of the jack lever, with the safety arm inserted to prevent accidental movement during the lifting procedure.

### DETAILED DESCRIPTION OF THE INVENTION

Referring now to FIG. 1, a jack lever 10 is shown, comprising a lever handle 11, and an extension arm 17, where said handle 11 and arm 17 are generally perpendicular to each other, so that their combination forms an “L” shape. The lever handle 11 may also comprise a lower lever portion 13, and an upper lever portion 12, with said portions 13 and 12 are attached to each other at a slight angle, so that they define a bend 14.

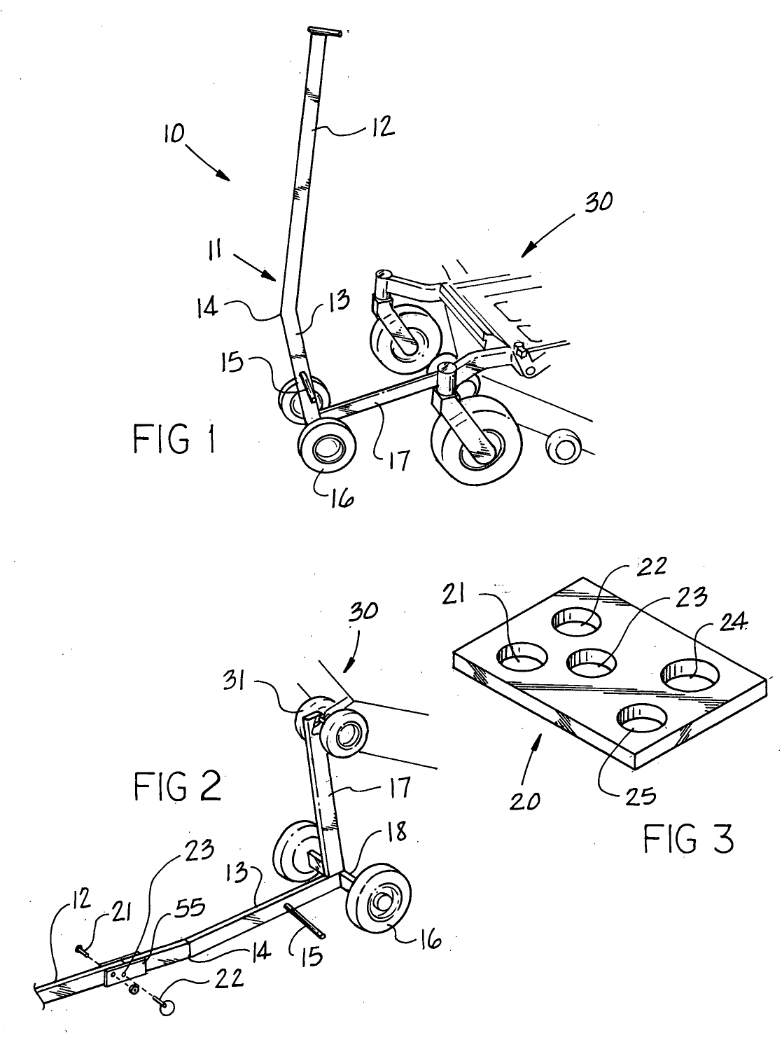

Referring now also to FIG. 2, the jack lever 10 may define a foot rest 15, which protrudes outward from the lower portion 13 of the lever 10. The point where the extension 17 and the lower portion 13 are joined should also define an axle 18, which protrudes outward to the sides, and which defines wheels 16 on the distal ends of said axle 18.

The distal end of the extension arm 17 defines at least one hole, that is defined through from one side to the other, of the extension arm. This hole is referred to as the pivot hole 38. Also defined through the extension arm 17, in the same manner as the pivot hole 38, is an extension locking hole 39. Said holes 38 and 39 are offset from each other, with the pivot hole 38 being defined closer to the bottom side of the extension arm 17, where the bottom side is defined as the side that comes in contact with the ground surface when in a lowered position.

The jack lever 10 has two positions. The first is the resting position, where the extension arm portion 17 is fairly parallel to the ground surface, with the level handle 11 being perpendicular to the extension arm 17, so that the level handle 11 protrudes upward. The wheels 16 rest on the ground surface.

The second usable position for the lever jack 10 is in a raised position, where the lever handle 11 is lowered to the ground surface, with the extension arm 17 elevated upward. As FIG. 2 depicts, the angle between the extension arm 17 and the lower lever portion 13 is less than 90 degrees, so that when the lever handle 11 is lowered to the ground, the extension arm 17 will pivot around the wheels 16 from a ground parallel position, past a perpendicular or 90 degree position, relative to the ground, and pivot past the 90 degree angle, so that when the jack lever 10 is in a raised position, the extension arm 17 has rotated more than 90 degrees.

To connect the jack lever 10 to a mower, the mower deck may be fitted with a plate, 20, as shown in FIG. 3. The plate 20 is comprised of a sturdy material, such as steel plating, and defines multiple holes. FIG. 3 depicts two mounting holes 25, a flange lock hole 21, and a flange pivot hole 22. Also shown is an alternative hole 23, for use with different mower assemblies.

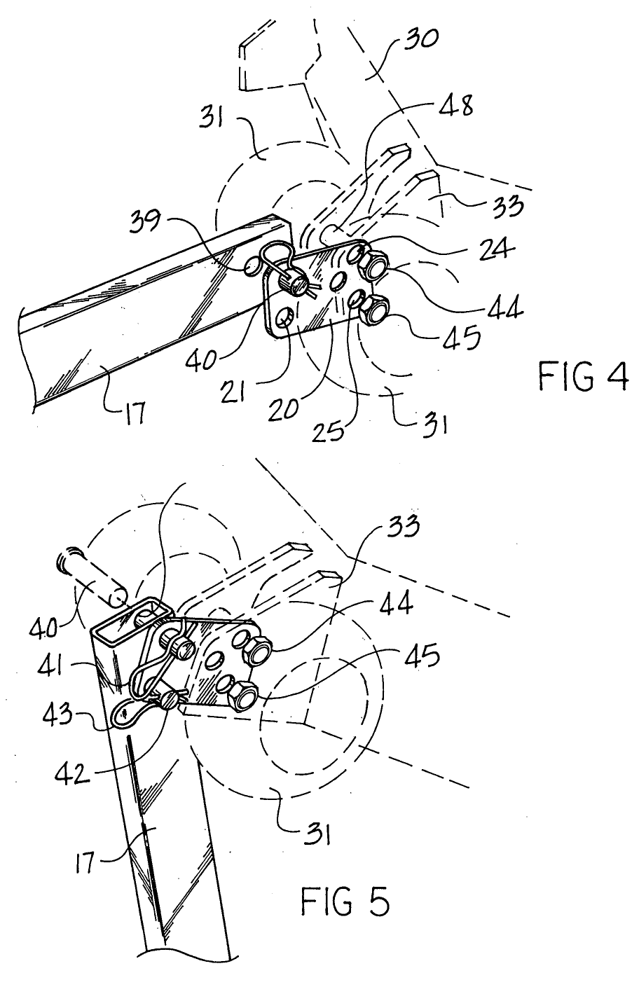

Referring now also to FIGS. 4 and 5, a portion of the mower deck 30 is shown, in which the mower deck 30 defines forward protruding flanges 33, and deck wheels 31. These wheels 31 are common on many mower decks, with the flanges 33 supplying a useful attachment point for the jack lever 10.

The plate 20 is fixed to the mower deck flanges 33, using bolts and mounting nuts 44 and 45, which are used to tighten bolts placed through the plate mounting deck holes 24 and 25. Alternatively, the plate 20 may be welded to the flange 33, or the flange 33 may protrude significantly enough so as to define a suitable area to attach the extension arm 17.

As is shown in FIG. 4, the extension arm 17 is attached to the plate 20, using a pivot pin 40, which is placed through the pivot pin hole 38 of the extension arm 17, and also through the fixed plate 20. A clip 41 may be used to hold the pin 38 in this position. At this time, the jack lever 10 may be used to elevate the mower deck 30.

To raise the mower deck 30, the jack lever 10 is moved from the lowered position, as shown in FIG. 1, to an elevated or raised position, as shown in FIG. 2, by causing the lever arm 11 to lower toward the ground, pivoting around the wheels 16, which causes the extension arm 17 to move upward, and to raise up the front portion of he mower deck 30, so as to allow access to its underside. It should be noted, that as the extension arm moves upward to a 90 degree orientation, the mower deck 30 will be at its highest level of elevation. As the extension arm 17 moves past 90 degrees, the mower deck 30 will lower slightly, as the distal end of the extension arm 17 moves slightly downward to a resting elevated position, as shown in FIG. 2.

The angles of the lever handle 11, in comparison to the extension arm, allow a portion of the lever handle 11 to impact the ground surface, and also to allow the distal end of the lever handle 11 to be slightly elevated, so as to provide an easy grip for reversing this action. Lowering the mower deck 30 back to the ground surface will require that the extension arm 17 elevate the mower deck 30 slightly, before lowering the deck 30 back to the ground surface. This provides a safeguard against accidental lowering.

To ensure additional safety from accidental lowering, the extension arm 17 defines a second hole, shown in FIG. 4 and 5 as the extension lock hole 39. When the mower deck 30 is in a lowered position, the extension lock hole 39 is not in line with any holes 21-25 defined within the plate 20. However, when the extension arm 17 is in a resting elevated position, the extension lock hole 39 will match the bore of the flange lock hole 21, defined on the plate 20. A locking pin 42 is placed through said holes 39 and 21, and may be held in place with clip 43, as shown in FIG. 5. This prevents accidental movement of the extension arm 17, in relation to the mower deck 30.

Since the pins 38 and 42 are removable when desired, the jack lever 10 is not required for permanent attachment to a mower deck 30. The jack lever 10 may also have a detachable handle, where the upper portion 12 is attached through a plate 55, which is fixed to the upper 12 portion and lower 13 portion, and also allows for said portions 12 and 13 to be detached from each other to assist in storage.

The foot rest 15 is not required, but greatly assists in allowing a person to press down on the lever handle 11, as the wheels 16 will move forward slightly toward the mower deck 30, as the extension arm 17 elevates.

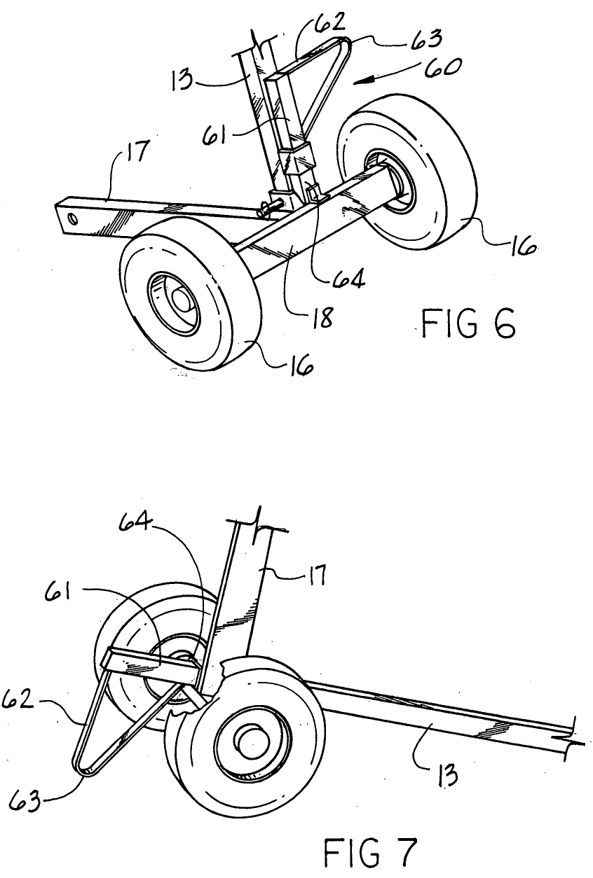

An additional safety feature is also shown in FIGS. 6 and 7. Referring now to FIG. 6, a safety arm 60, comprising a frame member 61, with a fixed extension loop 62 is shown attached to the jack lever handle 13, when not in use. The safety arm 60 has a end 64 that is able to be inserted into a receiving cavity, which is the interior tubular opening of the bottom end of the jack lever handle 13. Referring now also to FIG. 7, the safety arm end 64 is inserted into the bottom opening of the jack lever handle 13, which provides an extension of the jack lever handle 13 past the axle 18 portion. The safety arm 60 defines an extension loop 62, that extends downward, and impacts the ground on its farthest end 63. It should be understood that the extension loop 62 may comprise any type of resilient means, such as a single bracket, arm, or frame member. The use of a loop should in no way restrict the scope of this invention to a loop requirement. The loop 62 shown is depicted in FIG. 6 and FIG. 7, because it also provides an convenient handle in which to grasp the extension arm 60 during use. When the extension arm 60 is in place, the rotation of the jack lever 10 is fixed, and the mower deck 30 is unable to be lowered to the ground.

The safety arm 60 may be fixed to the jack lever handle 13, by inserting it inside the tubing of said handle 13, or it may be attached in any manner commonly known and understood in the art.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims. understood that the extension loop 62 may comprise any type of resilient means, such as a single bracket, arm, or frame member. The use of a loop should in no way restrict the scope of this invention to a loop requirement. The loop 62 shown is depicted in FIG. 6 and FIG. 7, because it also provides an convenient handle in which to grasp the extension arm 60 during use. When the safety arm 60 is in place, the rotation of the jack lever 10 is fixed, and the mower deck 30 is unable to be lowered to the ground.

The safety arm 60 may be fixed to the jack lever 13, by inserting it inside the tubing of said handle 13, or it may be attached in any manner commonly known and understood in the art, such as through a separate attachment point.

From the foregoing statements, summary and description in accordance with the present invention, it is understood that the same are not limited thereto, but are susceptible to various changes and modifications as known to those skilled in the art and we therefore do not wish to be limited to the details shown and described herein, but intend to cover all such changes and modifications which would be encompassed by the scope of the appended claims.

1-8. (canceled)

9. A lift for raising a mower over a ground surface, the lift comprising:
(a) left and right wheels positioned upon the ground surface;
(b) an axle member spanning between the left and right wheels;
(c) a lever arm and a lift arm extending from the axle member, the lift arm having a distal end, the lever and lift arms being pivotable between first and second positions, the lift arm extending forwardly along the ground surface and the lever arm extending upwardly from the ground surface while the lift and lever arms are in the first positions, the lift arm extending upwardly from the ground surface and the lever arm extending rearwardly along the ground surface upon pivoting motions of the lift and lever arms from the first positions to the second positions;
(d) a safety arm;
(e) means for interchangeably mounting the safety arm, said means being adapted so that while the lift and lever arms are in the first positions, the safety arm comprises a foot rest extending leftwardly or rightwardly from the lever arm, and so that while the lift and lever arms are in the second positions, the safety arm comprises a safety brace extending downwardly to the ground surface; and
(f) mower engaging means fixedly attached to the lift arm's distal end.

10. The lift of claim 9 wherein the lever arm comprises a tube having a handle end, and having an end opposite the handle end, the tube end opposite the handle end being opened, and wherein the interchangeable mounting means comprises said tube's open end.

11. The lift of claim 10 wherein the safety arm comprises a bar and a slide shaft, the bar being fixedly attached to and extending laterally from the slide shaft.

12. The lift of claim 11 wherein the interchangeable mounting means further comprises an end of the slide shaft, said slide shaft end being fitted for sliding receipt within the tube's open end.

13. The lift of claim 12 wherein the interchangeable mounting means further comprises a slide sleeve fitted for receiving the slide shaft's end, the slide sleeve being fixedly attached to the lever arm.

14. The lift of claim 13 wherein the bar has a lateral end, and further comprising an angle brace member spanning between said lateral end and the slide shaft.
